(19) United States
(12) Patent Application Publication
(10) Pub. No.: US 2021/0059325 A1
(43) Pub. Date: Mar. 4, 2021

(54) Outerwear Having Active Thermal Exchange

(71) Applicant: Purdue Research Foundation, West Lafayette, IN (US)

(72) Inventor: Kazuaki Yazawa, West Lafayette, IN (US)

(21) Appl. No.: 17/011,989

(22) Filed: Sep. 3, 2020

Related U.S. Application Data
(60) Provisional application No. 62/895,303, filed on Sep. 3, 2019.

(51) Int. Cl. A41D 13/005; A41D 1/00; F25B 21/02

(52) U.S. Cl. CPC A41D 13/0053; F25B 21/02; A41D 1/002

(57) ABSTRACT

An outerwear garment includes a jacket, at least one thermoelectric module, a thermal spreading pad and a mesh cover. The jacket has a flexible garment layer conforming to all or part of the human torso. The thermoelectric module (TEM) is coupled to the garment layer and has first and second sides. The TEM provides a temperature change between the first side and the second side responsive to applied electrical operating power. The thermal spreading pad has a surface thermally coupled and substantially conforming to at least a portion of the human torso, and exchanges heat with the first side of the TEM. The flexible mesh cover is coupled to the garment layer and disposed over the TEM. The jacket also supports an electrical power source that provides electrical operating power to the TEM.

This application claims the benefit of U.S. Provisional Patent Application Ser. No. 62/895,303, filed Sep. 3, 2020, the entirety of which is incorporated herein by reference.

### FIELD OF THE INVENTION

The present invention relates to outerwear, and particular, with active temperature adjustments.

### BACKGROUND

In general, outerwear such as jackets and parkas provide warmth using heat retention and insulation from the cold. A typical parka, for example, includes an outer shell, an inner liner and insulating fill therebetween. The various layers assist in insulation and heat retention properties of the garment as is well known in the art. In some cases of hard sporting exercise, such insulation disturbs the perspiration, and the further heat retention can lead to hyperthermia, even though the outside air temperature is still way below the temperature of comfort.

In other cases, to address colder weather without hard exercise, efforts have been made to add active heating elements to jackets. One common practice is to incorporate battery-powered carbon fiber infrared heating elements into the jacket. Such devices, however, have limited efficiency in the conversion of electricity to heat, which limits useful battery charge duration. In addition, such devices only provide heating to the body, and do not provide cooling.

### SUMMARY

At least some embodiments of the invention address one or more of the above-described shortcomings of the prior art by providing a jacket with active thermal exchange based on thermoelectric technology.

A first embodiment is an outerwear garment that includes a jacket, at least one thermoelectric module, a thermal spreading pad and a mesh cover. The jacket has a flexible garment layer conforming to all or part of the human torso. The thermoelectric module (TEM) is coupled to the garment layer and has first and second sides. The TEM provides a temperature change between the first side and the second side responsive to applied electrical operating power. The thermal spreading pad has a surface thermally coupled and substantially conforming to at least a portion of the human torso, and exchanges heat with the first side of the TEM. The flexible mesh cover is coupled to the garment layer and disposed over the TEM. The jacket also supports an electrical power source that provides electrical operating power to the TEM.

The advantages of various embodiments discussed herein, as well as others, will become more readily apparent to those of ordinary skill in the art by reference to the following detailed description and the accompanying drawings.

### BRIEF DESCRIPTION OF THE DRAWINGS

FIG. 1 shows a back plan view of an exemplary outerwear garment according to a first embodiment;

FIG. 2 shows a side plan view of an exemplary outerwear garment according to a first embodiment;

FIG. 3 shows a representative, fragmentary cutaway view of a thermal assembly and a shoulder of a human torso wearing the outerwear garment of FIG. 1;

FIG. 4 shows an exemplary thermoelectric module;

FIG. 5 shows an exemplary TEM assembly that may be used in the thermal assembly of FIG. 3;

FIG. 6 shows a schematic diagram of an exemplary electronics module that may be used in connection with the thermal assembly of FIG. 3; and

FIG. 7 shows a representative, fragmentary cutaway view of another embodiment of a thermal assembly and a shoulder of a human torso.

### DETAILED DESCRIPTION

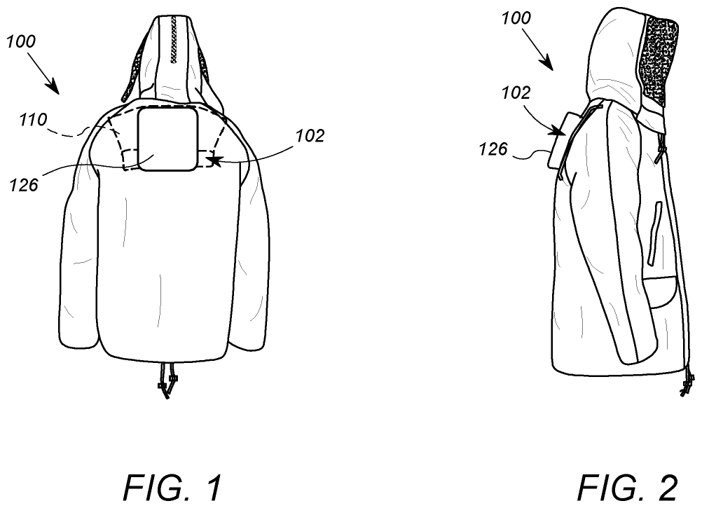

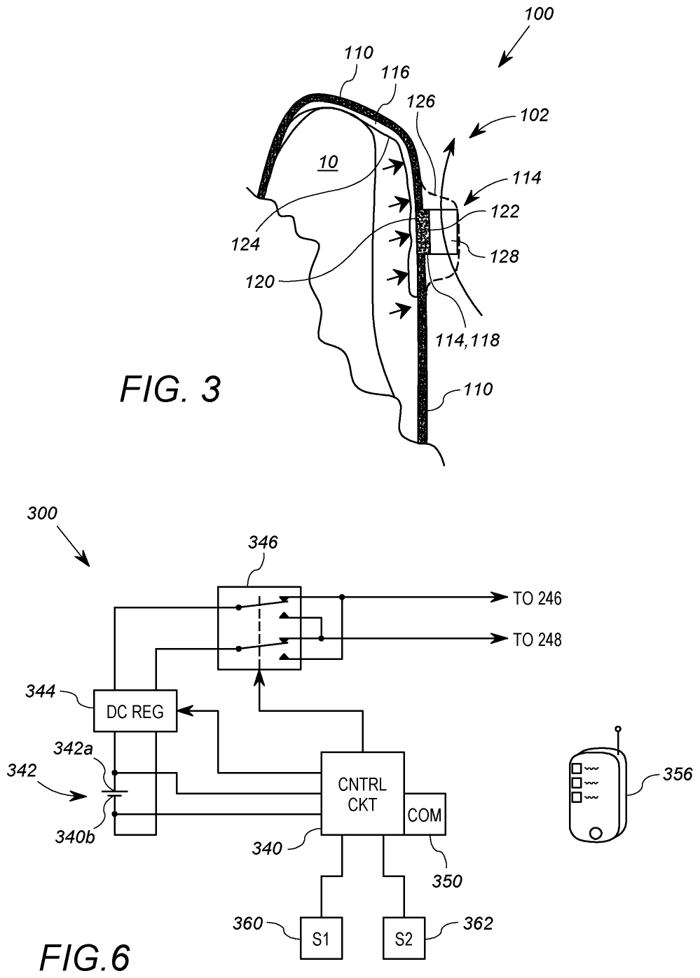

A first embodiment of an outerwear garment 100 is shown in FIGS. 1 and 2. In general, the outerwear garment includes a thermal assembly 102, and an electronics module, not shown, but see FIG. 6. The electronics module is suitably supported on the outerwear garment 100, preferably, but not necessarily, in proximity to the thermal assembly 102. It will be appreciated that the aesthetic and other aspects of the garment 100 not discussed herein may take any suitable form, and are not limited to the example of FIGS. 1 and 2. FIG. 3 shows a representative, fragmentary cutaway view of the thermal assembly 102 and a shoulder 10 of a human torso wearing the outerwear garment 100 of FIG. 1.

With simultaneous references to FIGS. 1, 2 and 3, the outerwear garment 100 is a jacket having at least one flexible garment layer 110 configured to be supported on a human torso 10. The thermal assembly 102 includes a thermoelectric (TEM) assembly 114 having one or more thermoelectric modules 118 and thermal spreading pad 116. The TEM assembly 114 is coupled to the flexible garment layer 110 such that the flexible garment layer 110 does not cover the thermoelectric module 118 (or at least heat sinks attached to the module 118) from the ambient environment external to the garment 100. In some embodiments, the flexible garment layer 110 can be the inner liner of the jacket, with the TEM assembly 114 located in a void in the outer shell of the jacket. In other embodiments, the flexible garment layer can be the outer shell of the jacket. Regardless, at least the outermost part of the TEM assembly 114 preferably is not covered by the flexible garment layer 110.

As shown in FIGS. 1 and 2, the garment layer 110 should be located at least in part in the vicinity of the shoulder blades of the high back of the wearer, and may cover the lower parts of the neck and the shoulders. Such placement focusses the heat exchange with the wearer at a sensitive part of the body. The TEM assembly 114 in this embodiment is supported just below the neck at least in part between the shoulder blades to reduce the strain on the user.

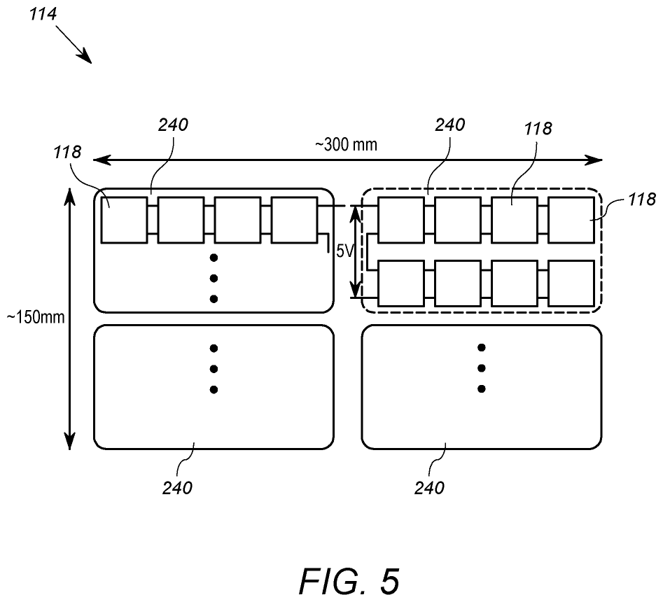

As will be discussed below in further detail in connection with FIG. 5, the at least one thermoelectric module 118 has a first side 120 and a second side 122, and is configured to provide a temperature change between the first side 120 and the second side 122 responsive to applied electrical operating power. To this end, the jacket 100 is further configured to support a source of electrical power such that the source of electrical power is operably coupled to provide electrical operating power to the thermoelectric modules 118 of the TEM assembly 114.

As discussed above, the thermal spreading pad 116 is a flexible pad or assembly having a surface 124 thermally coupled and substantially conforming to at least a portion of the human torso 10. The thermal spreading pad 116 is configured to exchange heat with the first side 120 of each thermoelectric module 118 of the TEM assembly 114.

The jacket 100 also includes a flexible mesh cover 126 operably coupled to the at least one flexible garment layer 110 and disposed over the TEM assembly 114 such that each thermoelectric module 118 is disposed between the thermal spreading pad 116 and the flexible mesh cover 126. The mesh cover 126 allows air flow from the environment external to the jacket 100 past the second side 122 of each module 118 of the TEM assembly 114. Thus, no other part of the jacket 100 should cover the second side 122 of the modules 118 of the TEM assembly 114.

In addition, the TEM assembly 114 further includes a heat sink 128 physically and thermally coupled to the second side 122 of each of the modules 118. In one embodiment, each heat sink 128 has a plurality of fins fixedly secured to (or integrally formed with) the second side 122 of each thermoelectric module 118. In this embodiment, the fins have a height of at least 20 mm and there is at least a 5 mm gap between adjacent fins. The heat sink 128 is disposed between the thermal spreading pad 116 and the flexible mesh cover 126. It will be appreciated that the use of the heat sink 128 covers the second side 122 of each thermoelectric module in whole or in part, so that the mesh cover 126 acts to allow air flow to the heat sink 128, as opposed to the second side 122 of the modules 118. The mesh cover 126 preferably is a coarse mesh that covers and hides (but may leave at least partly visible) the fins.

In some cases, a fan or other means of moving air may be added on the side of the fin tip of the heat sink 128, so that the efficiency of the heat exchange is improved. As discussed below, some embodiments may include a cooling mode, in which case a fan can help exchanging heat with the ambient environment.

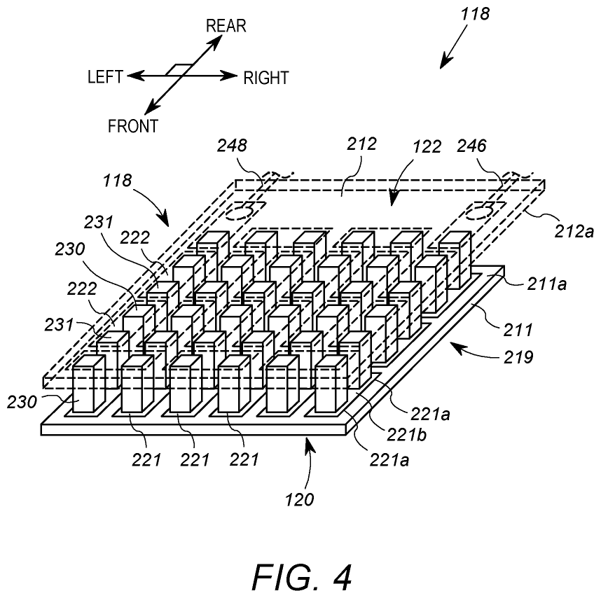

Each thermoelectric module 118 is operably coupled to exchange heat with, and generate a thermal change in, the thermal spreading pad 116. To this end, each thermoelectric module 118 may be a suitable commercially available thermoelectric module such as those available from Ferrotec at ferrotec.com. In general, a suitable example of a thermoelectric module is shown in FIG. 4.

In the exemplary embodiment of FIG. 4, the thermoelectric module 118 includes two insulating substrates 211, 212, plural electrodes 221, 222, and a plurality of thermoelectric elements, such as Peltier elements 230, 231. The electrodes 221, 222 are formed on the insulating substrates 211, 212 respectively. The, and plural peltier elements 230, 231 mounted to each of electrodes 221, 222. The insulating substrates 211, 212 have a substantially plate-like shape, and may suitably be made of aluminum or other material. The outer side of the substrate 211 is the first side 120 of the module 118, and the outer side of the substrate 212 is the second side of the module 122.

The electrodes and peltier elements are mounted to a first surface 211a of the first insulating substrate 211 that faces the second insulating substrate 212. Similarly, the electrodes and peltier elements are mounted to a first surface 212a of the second insulating substrate 212 facing the first insulating substrate 211. The electrodes 221 are formed on the first side 211a of the first insulating substrate 211, and the electrodes 222 are formed on the first side 212a of the second insulating substrate 212. The electrodes 221, 222 are formed in strip shapes and have substantially similar configurations.

Each of the first electrodes 221 includes a first side 221c abutting the first insulating substrate 211 and an opposing second side 221d. Two peltier elements 230, 231 are mounted (soldered) onto the second side 221d of each of the first electrode 221 in a longitudinal direction. The peltier elements 230, 231 are mounted (soldered) onto the second electrode 222 in a similar manner. The peltier elements 230 are formed as P-type peltier elements and the peltier elements 231 are formed as N-type peltier elements. As illustrated in FIG. 1, each of the peltier elements are connected so that the P-type peltier elements 230 and the N-type peltier elements 231 are arranged alternately in series via the electrodes 221 and the electrodes 222.

The thermoelectric module 118 further includes first and second terminals 246, 248. The plurality of peltier elements 230, 231 are series connected (as described above) by alternating doping type between first and second electrical terminals 246, 248. The thermoelectric module 118 is actuated by applying a voltage across the first and second terminals 246 and 248. The operation of thermoelectric module 118 under excitation voltages is known in the art, and will vary based on the specific configuration of the thermoelectric module 118, which can vary from that shown in FIG. 4.

Referring again to FIG. 1, the TEM assembly 114 in this embodiment is comprised of a plurality of thermoelectric modules 118. FIG. 5 shows a representative plan view schematic of the TEM assembly 114. It will be appreciated that the heat sinks 128, which are attached to the second side 122 of the thermoelectric modules 118, are not shown in FIG. 5 for purposes of clarity.

The TEM assembly 114 includes the plurality of thermoelectric modules 118 affixed to one or more flexible sheets 240. Although not specifically shown in FIG. 3, each flexible sheet 240 is thermally conductive and is operably secured to the at least one flexible garment layer 110. The plurality of thermoelectric modules 118 of each sheet 240 are electrically coupled in series. To allow for moderate flexibility, while still using readily available rigidly formed thermoelectric modules 118, each of the plurality of thermoelectric modules has a length and width of less than 40 mm.

Referring again to FIGS. 1, 2 and 3, the thermal spreading pad 116 has a surface 124 thermally coupled and substantially conforming to at least a portion of the human torso 10. The thermal spreading pad 116 is highly thermally conductive, and flexible. The thermal spreading pad 116 is preferably laminated or otherwise affixed to the inner liner of the jacket 100. The thermal spreading pad 116 is configured to exchange heat with the first side 120 of some or all of thermoelectric modules 118. The thermal spreading pad 116 thus is configured to act as a thermal conductor between the surface(s) of the thermoelectric module(s) 118 and any part of the torso 10 that the thermal spreading pad 116 contacts or is immediately adjacent to.

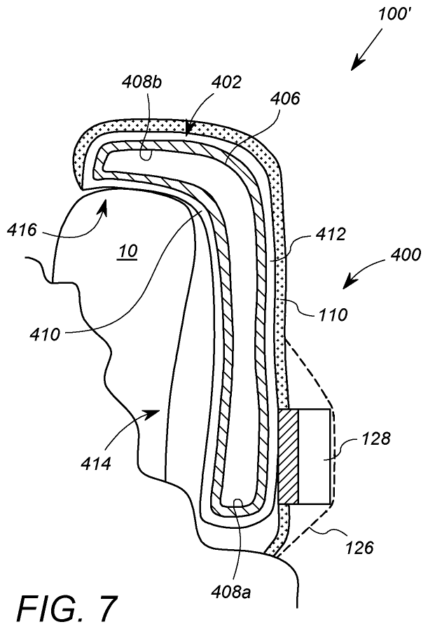

In some embodiments, the thermal spreading pad 116 is configured such that the surface 124 extends over and performs heat exchange with at least a portion of one or both shoulders of the torso 10 when the jacket is worn. In other embodiments, the thermal spreading pad 116 may be configured such that the surface 124 extends over and performs heat exchange with portions of the neck and/or back. To provide the thermal conductivity, the thermal spreading pad 116 may include one or more laminated layers of graphite and/or one or more aluminum or copper sheets. In an alternative embodiment discussed below in connection with FIG. 7, the thermal spreading device may be a vapor chamber.

FIG. 6 shows a simplified schematic diagram of an exemplary electronics module 300 that may be used in connection with the thermal assembly 102 of FIG. 3. The electronics module 300 in this embodiment supports a control circuit 340, a power storage unit 342, a DC regulator 344, and a double pole, double throw switch 346. It will be appreciated that one or more of the elements discussed above may be supported within the jacket 100 as a housed unit, or otherwise.

The power storage unit 342 is one or more devices that store power so that the thermal assembly 102 may be portably powered. In this embodiment, the power storage unit 342 comprises one or more chargeable batteries, by way of example, having a positive terminal 342a and a negative terminal 342b. The double pole double throw switch 346 in this embodiment is operably connected to selectively and alternately connect the first and second terminals 246, 248 of the thermoelectric module 118 to the positive and negative terminals 342a and 342b of the power storage unit 342. In other words, the switch 346, which may suitably be a relay, controllably reverses the polarity of the DC voltage applied to the thermoelectric module 118. In this way, the switch 346 is used to control whether the module 118 provides cooling to the thermal spreading pad 116, or heating to the thermal spreading pad 116. The control circuit 340 is operably connected to control the operation of the switch 346. It will be appreciated that other methods and devices may be used to control the polarity of the voltage applied to thermoelectric module 118 terminals 246, 248.

The DC regulator 344 is operably connected in the path between the power storage unit 342 and the switch 346, so as to provide a variable voltage to the thermoelectric module 118 under the control of the control circuit 340. Voltage regulators capable of generating a variable DC voltage responsive to a control signal are known.

The control circuit 340 can also include a communication circuit 350 configured to receive user control signals including control information from a user interface. In one embodiment, the information is received from a wireless computing device 356 having a user interface. The wireless computing device 356 may suitably be a smart phone. However, such control information may be received from other devices, including those with wired connections.

The received control information can include information identifying a value of at least one operating parameter of the thermoelectric module 118. Accordingly, the control information may include information identifying whether heating or cooling is to be applied, or in other words, the position of the switch 346. The control information may include the level of heating and/or cooling, which corresponds to the voltage level of the DC regulator 344. To this end, the wireless computing device 356 or other device has a user interface that allows a user to either specify operating levels of the thermoelectric module 118, or run a preprogrammed sequence of parameter sets that operate based on time or inputs from sensors, not shown. For example, the control circuit 340 may execute a program that provides heating and cooling based on body temperature sensors 360, 362, or other sensors, not shown. The sensors 360, 362 may be mounted on the garment 100 as required to capture the desired temperature measurement.

Accordingly, the control circuit 340 is a programmable device, processor, microcontroller, or the like, that is configured to, among other things, generate control signals to the DC regulator 344 and the switch 346, at least in part based on control information received from the communication circuit 350. As discussed above, however, the control circuit 340 may also include internal programs that adjust certain parameters levels for example based on inputs of sensors, not shown, but which relate to ambient temperature, the status of the power storage device 342, etc.

In operation, the control circuit 340 provides signals to the switch 346 and the voltage regulator 344 to control the operation of the thermoelectric modules 118 of the TEM assembly 114. Each thermoelectric module 118, operates to create a thermal gradient, as is known in the art. The heat sink fins 128 improve the efficiency of operation. The accumulated operation of the thermoelectric modules 118 of the TEM assembly 114 operate to change the temperature of the thermal spreading pad 116. The thermal spreading pad 116 operates to convey the heat exchange to the torso 10 adjacent the surface 124.

FIG. 7 shows a representative, fragmentary cutaway view of an alternative embodiment of a thermal assembly 400 and a shoulder of a human torso 10 wearing the outerwear garment 100′ that includes the thermal assembly 400.

The outerwear garment 100′ may suitably be substantially the same as the outerwear garment 100 of FIG. 1, except that the thermal assembly 102 has been replaced by the thermal assembly 400. Accordingly, structures from the garment 100′ bear the same reference numbers as like structures of the garment 100 in FIGS. 1 through 3, and may suitably have the same features. Similarly, the thermal assembly 400 is substantially the same as the thermal assembly 102 of FIGS. 1 to 6, except that the thermal spreading pad 116 has been implemented as a heat pipe 402. Accordingly, structures from the thermal assembly 400 bear the same reference numbers as like structures of the thermal assembly 102 in FIGS. 1 to 6, and may suitably have the same features.

Accordingly, the thermal assembly 400 includes the thermoelectric (TEM) assembly 114 having one or more thermoelectric modules 118 and the heat pipe 402. The TEM assembly 114 is coupled to the at least one flexible garment layer 110 such that the flexible garment layer 110 does not cover the thermoelectric module 118 (or at least heat sinks attached to the module 118) from the ambient environment external to the garment 100′. In some embodiments, the flexible garment layer 110 can be the inner liner of the jacket, with the TEM assembly 114 located in a void in the outer shell of the jacket. In other embodiments, the flexible garment layer can be the outer shell of the jacket. Regardless, at least the outermost part of the TEM assembly 114 should not be covered by the flexible garment layer 110.

As shown in FIGS. 1 and 2, the garment layer 110 should be located at least in part in the vicinity of the shoulder blades of the high back of the wearer, and may cover the lower parts of the neck and the shoulders. The TEM assembly 114 in this embodiment is below the neck at least in part between the shoulder blades to reduce the strain on the user. Because of the use of the heat pipe

As discussed above in further detail in connection with FIG. 5, the at least one thermoelectric module 118 has a first side 120 and a second side 122, and is configured to provide a temperature change between the first side 120 and the second side 122 responsive to applied electrical operating power.

The heat pipe 402 is an enclosed structure having an outer shell 404, wicking 406 and a vapor chamber 408. The outer shell 404 has an inner plate 410 and an outer plate 412 with the vapor chamber 408 extending in a vacuum sealed manner therebetween. The inner plate 410 has a back portion 414 and a shoulder portion 416. The shoulder portion 416 is configured to cover (contact or sit immediately adjacent to) at least a portion of one or both shoulders 10 of the torso wearer, extending at least in part in a medial-lateral direction as shown in FIG. 7. The back portion 414 is configured to extend downward from the shoulder portion 416 along at least portion of a wearer's back. The back portion 414 may suitably be of a width that extends laterally over a majority of the width of the wearer's back. The outer plate 412 is spaced apart from, and has a shape corresponding to, the inner plate 410, such that the vapor chamber 408 has a more or less consistent depth between the plates 410, 412. The outer plate 404 is formed of a thermally conductive material, such as copper, aluminum or nickel.

The wicking 406 preferably extends around the inner surfaces of the outer shell 404 and thus defines the outer perimeter of the vapor chamber 408. The wicking 406 may be a screen, a set of grooves, or sintered metal, such as that from which the outer plate 404 is made. The wicking 406 is designed to use capillary forces to convey water from the vapor chamber 408 within the heat pipe 402.

The lower portion of outer plate 412 (nearest the bottom of the back portion 414 of the inner plate 410) is configured to exchange heat with the first side 120 of each thermoelectric module 118 of the TEM assembly 114. The TEM assembly 114 may suitably have the structure discussed above in connection with FIG. 5. Each thermoelectric module 118 is operably coupled to exchange heat with, and generate a thermal change in, the vapor chamber 408. To this end, each thermoelectric module 118 may be a suitable commercially available thermoelectric module such as those available from Ferrotec at ferrotec.com. In general, a suitable example of a thermoelectric module is shown in FIG. 4, discussed above.

Referring again to FIG. 7, the heat pipe 402 is configured to exchange heat with the first side 120 of some or all of thermoelectric modules 118 near the bottom of the heat pipe 402, convey the heat via the vapor chamber 408 to the shoulder portion 416. The wicking 406 is configured to wick cooled liquid that results, for example, from the absorption of heat from the vapor by the shoulder 10. The wicking 406 is configured to wick the cooled liquid back to the bottom 408a of the chamber 408 where it can be heated again by the thermoelectric modules 118.

In some embodiments, the heat pipe 402 is configured such that the inner plate 410 extends over and performs heat exchange with at least a portion of one or both shoulders 10 of the torso when the jacket is worn. In other embodiments, the heat pipe 402 may be configured such that the inner plate 410 extends over and performs heat exchange with portions of the neck and/or back.

It will be appreciated that the thermal assembly 400 in this embodiment also employs the exemplary electronics module 300 of FIG. 3, but could employ other variants. Thus, the operation of the embodiment of FIG. 7 is discussed with additional reference to FIGS. 4, 5 and 6.

In a heating operation, the control circuit 340 provides signals to the switch 346 and the voltage regulator 344 to control the operation of the thermoelectric modules 118 of the TEM assembly 114. Each thermoelectric module 118, operates to create a thermal gradient wherein the cool side is the second side 122, and the hot side is the first side 120, adjacent the lower part of the outer plate 412. The accumulated operation of the thermoelectric modules 118 of the TEM assembly 114 (and the outer plate 412) operate to increase the temperature of the vapor in the bottom 408a of the vapor chamber 408. The heated vapor rises toward the top 408b of the vapor chamber 408, adjacent the shoulder portion 416 of the inner plate 410. Via the inner plate 410, heat from the vapor is applied to the shoulder 10 of the wearer. The transfer of heat causes the vapor to cool at the top 408b of the chamber 408, and condense. To this end, as is known in the art the vapor chamber 408 is configured to have a suitable gas pressure.

The cooled liquid then wicks down on the wicking 406 from the top 408b to the bottom 408a of the vapor chamber 408. At the bottom 408a of the vapor chamber 408, the first side 120 of the thermoelectric modules 118 apply heat that again vaporizes and causes the vapor to rise. As a consequence, the addition of heat to the chamber 408 by the thermoelectric modules 118 and the removal of heat from the chamber 408 by the shoulder 10 causes a continuous cycle.

The above described embodiments are merely exemplary, and those of ordinary skill in the art may readily devise their own modifications and implementations that incorporate the principles of the present invention and fall within the spirit and scope thereof.

What is claimed is:

1. An outerwear garment, comprising:
a jacket having at least one flexible garment layer configured to be supported on a human torso, the at least one flexible garment layer configured to conform to at least a portion of the human torso;
at least one thermoelectric module coupled to the at least one flexible garment layer, the at least one thermoelectric module having a first side and a second side and configured to provide a temperature difference between the first side and the second side responsive to applied electrical operating power;
a thermal spreading pad having a surface thermally coupled and substantially conforming to at least a portion of the human torso, the thermal spreading element configured to exchange heat with the first side of the at least one thermoelectric module; and
a flexible mesh cover operably coupled to the at least one flexible garment layer and disposed over the at least one thermoelectric module such that the at least one thermoelectric module is disposed between the thermal spreading pad and the flexible mesh cover;
wherein the jacket is further configured to support a source of electrical power such that the source of electrical power is operably coupled to provide electrical operating power to the at least one thermoelectric module.

2. The outerwear garment of claim 1, further comprising a heat sink having a plurality of fins fixedly secured to the second side of the at least one thermoelectric module, and wherein the heat sink is disposed between the thermal spreading pad and the flexible mesh cover.

3. The outerwear garment of claim 1, wherein the at least one thermoelectric module comprises a plurality of thermoelectric modules.

4. The outerwear garment of claim 3, wherein the plurality of thermoelectric modules are affixed to a flexible sheet, the flexible sheet operably secured to the at least one flexible garment layer.

5. The outerwear garment of claim 4, wherein the plurality of thermoelectric modules are electrically coupled in series.

6. The outerwear garment of claim 4, wherein each of the plurality of thermoelectric modules has a length and width of less than or equal to 60 mm.

7. The outerwear garment of claim 1, wherein the at least one thermoelectric module comprises a plurality of thermoelectric modules affixed to each of a plurality of flexible sheets, the flexible sheets operably connected to the at least one flexible garment layer.

8. The outerwear garment of claim 1, wherein the thermal spreading pad is configured such that the surface extends over at least a portion of a shoulder of the torso when the jacket is worn.

9. The outerwear garment of claim 1, wherein the thermal spreading pad includes a graphite sheet layer.

10. The outerwear garment of claim 1, wherein the thermal spreading pad includes an aluminum layer.

11. The outerwear garment of claim 1, further comprising a control circuit configured to control at least one parameter of operation of the thermoelectric module.

12. An outerwear garment, comprising:
a jacket having at least one flexible garment layer configured to be supported on a human torso, the at least one flexible garment layer configured to conform to at least a portion of the human torso;
at least one thermoelectric module coupled to the at least one flexible garment layer, the at least one thermoelectric module having a first side and a second side and configured to provide a temperature change between the first side and the second side responsive to applied electrical operating power;
a heat pipe having a surface thermally coupled and disposed adjacent to at least a portion of the human torso, the heat pipe configured to exchange heat with the first side of the at least one thermoelectric module and exchange heat with the portion of the human torso.
wherein the jacket is further configured to support a source of electrical power such that the source of electrical power is operably coupled to provide electrical operating power to the at least one thermoelectric module.

13. The outerwear garment of claim 12, wherein the at least one thermoelectric module comprises a plurality of thermoelectric modules.

14. The outerwear garment of claim 13, wherein the plurality of thermoelectric modules are affixed to a flexible sheet, the flexible sheet operably secured to the at least one flexible garment layer.

15. The outerwear garment of claim 12, wherein the at least one thermoelectric module includes a plurality of peltier elements of alternating doping types disposed between electrically non-conductive substrates, the plurality of peltier elements series connected by alternating doping type between first and second electrical terminals.

16. An outerwear garment, comprising:
a jacket having at least one flexible garment layer configured to be supported on a human torso;
at least one thermoelectric module coupled to the at least one flexible garment layer, the at least one thermoelectric module having a first side and a second side and configured to provide a temperature change between the first side and the second side responsive to applied electrical operating power;
a source of electrical power supported on the jacket, the source of electrical power operable coupled to provide electrical operating power to the at least one thermoelectric module;
a thermal spreading device having a surface thermally coupled to at least a portion of the human torso, the thermal spreading element configured to exchange heat with the first side of the at least one thermoelectric module; and
a control circuit operably coupled to control the polarity of DC voltage applied to the at least one thermoelectric module.

17. The outerwear garment of claim 16, wherein the control circuit includes a wireless communication circuit configured to receive wireless signals including control information, and wherein the control circuit is further configured to control at least one operating parameter of the at least one thermoelectric module based on the received control information.

18. The outerwear garment of claim 16, wherein the at least one thermoelectric module includes a plurality of peltier elements of alternating doping types disposed between electrically non-conductive substrates, the plurality of peltier elements series connected by alternating doping type between first and second electrical terminals.

19. The system of claim 18, further comprising a double pole double throw switch operably connected to first and second electrical terminals of the power storage unit to provide selectively alternate voltage polarity to the at least one thermoelectric module.
